(19) United States
(12) Patent Application Publication
(10) Pub. No.: US 2007/0214475 A1
(43) Pub. Date: Sep. 13, 2007

(54) Viewing/listening restriction apparatus and method for digital broadcast

(75) Inventors: Yeon Ju Lee, Suwon-si (KR); Sang Hyeon Yoon, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/650,326

(22) Filed: Jan. 5, 2007

(30) Foreign Application Priority Data
Mar. 8, 2006 (KR) 2006-0021778

(51) Int. Cl. H04N 7/16; H04N 7/167

(52) U.S. Cl. 725/31; 725/25; 725/28

(57) ABSTRACT

A viewing and listening restriction apparatus and method for digital broadcast are disclosed. A digital broadcast receiver receives authentication information through a wireless communication network, registers the authentication information, sets viewing/listening restriction information according to an authorized user's selections, and applies viewing and listening restriction to digital broadcast on the basis of the viewing and listening restriction information. As a result, viewing and listening restriction can be applied to a digital multimedia broadcasting (DMB) phone by blocking broadcast operation on the basis of preset conditions.

### PRIORITY

This application claims priority under 35 U.S.C. § 119 from Korean Patent Application No. 2006-0021778, filed in the Korean Intellectual Property Office on Mar. 8, 2006, the contents of which are incorporated herein by reference.

### BACKGROUND OF THE INVENTION

1. Field of the Invention

The present invention relates generally to digital broadcasting and, more particularly, to a viewing and listening restriction apparatus and method for digital broadcast.

2. Description of the Related Art

In digital multimedia broadcasting (DMB), various multimedia signals including audio and video are digitally modulated and delivered to users. Particularly, users in motion can receive various multimedia programs through portable or in-vehicle receivers equipped with an omni-directional receiving antenna.

Advances in memories capable of storing vast amounts of digital multimedia data such as moving pictures and music videos, and popularization of mobile communication terminals, have enabled recent development and commercialization of mobile communication terminals having DMB reception capabilities, such as DMB phones.

A user can receive DMB programs through a DMB phone while in motion. As such, a user in motion can readily carry a DMB phone and enjoy favorite DMB programs at almost any time and place.

Of particular note, there has been an increasing amount of youths who are carrying DMB phones, for such applications as viewing educational programs. However, unrestricted viewing/listening to DMB programs may be harmful to adolescents. For example, adolescents who view/listen to DMB programs in an uncontrolled manner may waste time and be exposed to programs that are not befitting of youth viewing. Consequently, it is desirable to provide viewing/listening restriction functions for broadcast in DMB phones for youths.

### SUMMARY OF THE INVENTION

The present invention has been made in view of the above problems, and an object of the present invention is to provide a viewing/listening restriction apparatus and method for digital broadcast wherein viewing/listening restriction can be applied to a digital multimedia broadcasting (DMB) phone by blocking broadcast viewing/listening of the DMB phone on the basis of preset conditions.

Another object of the present invention is to provide a viewing/listening restriction apparatus and method for digital broadcast wherein broadcast operation of a DMB phone can be blocked by another person other than the user of the DMB phone.

Another object of the present invention is to provide a viewing/listening restriction apparatus and method for digital broadcast wherein broadcast operation of a DMB phone can be remotely controlled through a mobile communication network.

In accordance with the present invention, there is provided a viewing/listening restriction method for digital broadcast in a digital broadcast receiver, including a) receiving, by the digital broadcast receiver, authentication information through a wireless communication network and registering the received authentication information, b) setting viewing/listening restriction information for digital broadcast on the basis of selections of a restricting user authorized through the authentication information, and c) applying viewing/listening restriction to the digital broadcast receiver on the basis of the viewing/listening restriction information.

Step a) further includes a-1) receiving, by the digital broadcast receiver, a text message containing the authentication information through the wireless communication network, a-2) requesting a restricted user to accept the authentication information, and a-3) storing the authentication information according to user acceptance.

At step b) the digital broadcast receiver receives time information containing the authentication information through the wireless communication network. The time information may be a time interval to wait before application of viewing/listening restriction, or a specified start time of viewing/listening restriction.

Alternatively, at step b) a program to be viewing/listening-restricted may be selected and set as the viewing/listening restriction information.

Step c) includes extracting a program identifier (PID) from received digital broadcast data, determining whether the extracted PID is contained in the list of viewing/listening-restricted programs, blocking, if the extracted PID is contained in the list, output of the digital broadcast data, and unblocking, if the extracted PID is not contained in the list, output of the digital broadcast data.

Alternatively, step c) may include extracting a PID from received digital broadcast data, determining whether the extracted PID is contained in the list of viewing/listening-restricted programs, extracting, if the extracted PID is contained in the list, an end time of a program associated with the PID from the pre-stored electronic program guide, blocking reception of digital broadcast data until the end time of the program, and unblocking reception of digital broadcast data after the end time of the program.

The viewing/listening restriction method further includes d) setting viewing/listening restriction removal information for digital broadcast on the basis of selections of the restricting user authorized through the authentication information, and e) removing viewing/listening restriction from the digital broadcast receiver on the basis of the viewing/listening restriction removal information.

In accordance with the present invention, there is also provided a digital broadcast receiver including a wireless communication module for receiving authentication information for setting viewing/listening restriction information for the digital broadcast receiver via a wireless communication network, a digital broadcast receiving unit for receiving digital broadcast data, a digital broadcast data processor for processing the received digital broadcast data, a digital broadcast data output unit for outputting the processed digital broadcast data, a key pad for inputting an operation command from a user, a controller for setting viewing/listening restriction information for digital broadcast according to selections of a user authorized through the authentication information, and for applying viewing/listening restriction to the digital broadcast receiver on the basis of the viewing/listening restriction information, and a memory unit for storing the authentication information and viewing/listening restriction information.

The keypad receives time information from the authorized user and transmits the time information as the viewing/listening restriction information to the controller. The time information may be used for application of viewing/listening restriction to digital broadcast, and be one of a time interval to wait before application of viewing/listening restriction and a specified start time of viewing/listening restriction.

Alternatively, the viewing/listening restriction information may be information on a viewing/listening-restricted program.

To set the viewing/listening restriction information, the controller extracts a program identifier (PID) of the viewing/listening-restricted program from a pre-stored electronic program guide, and stores the extracted PID in the memory unit.

To apply viewing/listening restriction, the controller determines whether a PID extracted from received digital broadcast data is stored in the memory unit, then blocks, if the PID is stored in the memory unit, output of the digital broadcast data, and unblocks, if the PID is not stored in the memory unit, output of the digital broadcast data.

Alternatively, to apply viewing/listening restriction, the controller determines whether a PID extracted from received digital broadcast data is stored in the memory unit, and blocks, if the PID is stored in the memory unit, reception of digital broadcast data until an end time of a program associated with the PID.

The wireless communication module receives a text message containing the authentication information, from a mobile communication terminal remotely controlling the digital broadcast receiver, through the wireless communication network.

The keypad receives time information from the authorized user and transmits the time information as viewing/listening restriction removal information to the controller. The time information may be used to remove viewing/listening restriction for digital broadcast, and be one of a time interval to wait before removal of viewing/listening restriction and a specified start time of viewing/listening restriction removal.

In accordance with the present invention, there is further provided a mobile communication terminal including a remote control processor for creating a control message to control digital broadcast operation of an external appliance through a mobile communication network, an input unit for inputting an operation command from a user to remotely control the external appliance, a controller for controlling the remote control processor in response to the operation command, and a wireless communication unit for transmitting the control message created by the remote control processor to the external appliance.

The remote control processor creates at least one of a password change message to change a password that is stored in the external appliance for verification of a right to control digital broadcast operation, an viewing/listening restriction message to apply viewing/listening restriction to the external appliance, and an viewing/listening restriction removal message to remove viewing/listening restriction from the external appliance.

The input unit includes a remote control key for remotely controlling digital broadcast operation of the external appliance.

### BRIEF DESCRIPTION OF THE DRAWINGS

The above and other objects, features and advantages of the present invention will be more apparent from the following detailed description in conjunction with the accompanying drawings, in which:

FIG. 1 illustrates the configuration of a digital broadcast receiver according to the present invention;

FIGS. 2A to 2C illustrate structures of databases for managing viewing/listening restriction information in the digital broadcast receiver of FIG. 1;

FIG. 3 is a flow chart illustrating a viewing/listening restriction method according to a first embodiment of the present invention;

FIGS. 4A to 4C are flow charts illustrating steps of a viewing/listening restriction method according to a second embodiment of the present invention;

FIGS. 5A to 5B are flow diagrams illustrating a viewing/listening restriction method according to a third embodiment of the present invention;

FIGS. 6A to 6C illustrate structures of messages exchanged to perform operations necessary for the viewing/listening restriction method of FIGS. 5A to 5B;

FIG. 7 illustrates the configuration of a mobile communication terminal according to the present invention; and

FIGS. 8A to 8N are display screens illustrating steps to remotely control operation of digital multimedia broadcasting using the mobile communication terminal of FIG. 7.

### DETAILED DESCRIPTION OF THE PREFERRED EMBODIMENTS

Hereinafter, preferred embodiments of the present invention are described in detail with reference to the accompanying drawings. The same reference symbols identify the same or corresponding elements in the drawings. Some constructions or processes known in the art are not described for the sake of clarity and conciseness.

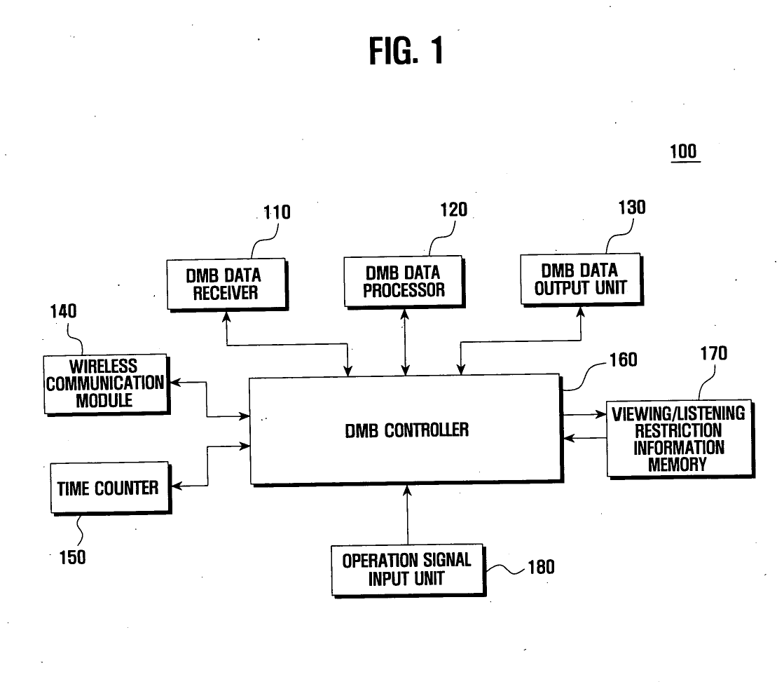

FIG. 1 illustrates the configuration of a digital broadcast receiver according to the present invention. Referring to FIG. 1, the digital broadcast receiver 100 includes a DMB data receiver 110, a DMB data processor 120, a DMB data output unit 130, a wireless communication module 140, a time counter 150, a DMB controller 160, a viewing/listening restriction information memory 170 and an operation signal input unit 180.

The DMB data receiver 110 receives DMB data by selectively tuning to, for example, a code division multiplexing (CDM) channel according to user selections. The DMB data receiver 110 preferably includes an omni-directional antenna.

The DMB data processor 120 processes the DMB data received by the DMB data receiver 110, and sends the processed DMB data to the DMB data output unit 130. For example, the DMB data processor 120 detects MPEG-4 coded data from the DMB data received in the form of a Moving Picture Experts Group 2 (MPEG-2) transport stream, and decodes digital audio data and digital video data to output the data. To this end, the DMB data processor 120 preferably includes a TS demultiplexer, audio/video buffer and A/V codec.

The DMB data processor 120 also detects a program identifier (PID) in the received DMB data and sends the detected PID to the DMB controller 160.

The DMB data output unit 130 outputs data processed by the DMB data processor 120, and preferably includes a speaker for outputting audio data and a display section for outputting video data.

The wireless communication module 140 provides a communication interface to wireless communication networks.

The time counter 150 counts time, and sends the count result to the DMB controller 160.

The DMB controller 160 controls DMB operation of the digital broadcast receiver 100 according to executable programs set in advance or user commands through the operation signal input unit 180. For example, the DMB controller 160 applies viewing/listening restriction to the digital broadcast receiver 100 on the basis of viewing/listening restriction information (for example, time intervals and programs to be restricted) pre-stored in the viewing/listening restriction information memory 170. When information on a program to be viewing/listening-restricted is input from the operation signal input unit 180, the DMB controller 160 stores the information in the viewing/listening restriction information memory 170. In particular, when the DMB user selects the current program, the DMB controller 160 preferably detects the PID of DMB data currently being played, and inserts the detected PID into a list of viewing/listening-restricted PIDs. The PID is detected from an electronic program guide (EPG) of current programs.

The DMB controller 160 also controls DMB operation of the digital broadcast receiver 100 according to a control message (for example, a text message) received through the wireless communication module 140, or a control command transmitted from a remote site. The wireless communication module 140 receives a control message containing a control command and related authentication information, transmits the control message to the DMB controller 160 and the viewing/listening restriction information memory 170 pre-stores authentication information of the user authorized to control DMB operations of the digital broadcast receiver 100. In this case, the DMB controller 160 compares the authentication information contained in the control message with that stored in the viewing/listening restriction information memory 170, and performs, if they are identical, the control command (for example, a DMB reception on or off command) contained in the control message.

When a password change message containing related authentication information, an old password and a new password, is received through the wireless communication module 140, the DMB controller 160 changes a password for operation control on the basis of the password change message. The DMB controller 160 determines whether the corresponding user possesses the authority to change the password by the authentication information contained in the password change message. If the user possesses the authority to change the password, the DMB controller 160 compares the old password contained in the password change message with the pre-stored password. If they are identical, the DMB controller 160 preferably replaces the pre-stored password with the new password contained in the password change message.

The viewing/listening restriction information memory 170 stores viewing/listening restriction information necessary to control viewing/listening restriction functions applicable to the digital broadcast receiver 100. For example, the viewing/listening restriction information memory 170 stores a list of time intervals to be viewing/listening-restricted, a list of programs to be viewing/listening-restricted, and authentication information to certify control messages from a remote site.

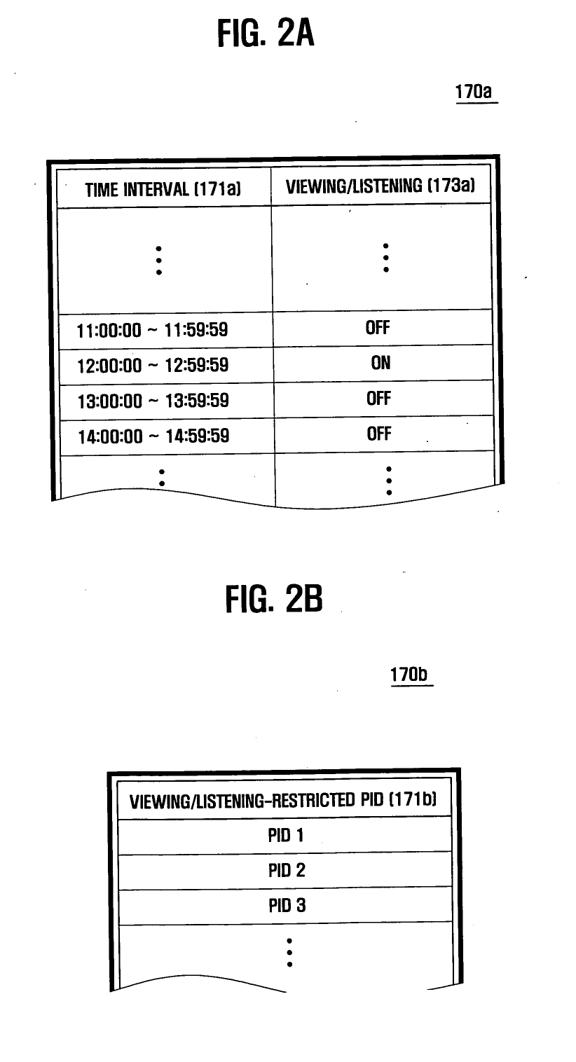

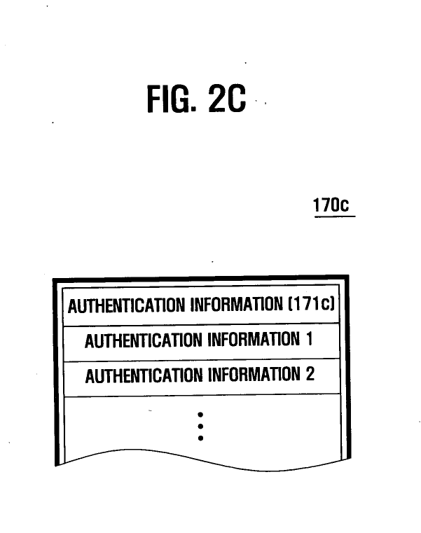

FIGS. 2A to 2C illustrate structures of records in databases to maintain the viewing/listening restriction information. The databases are stored in the viewing/listening restriction information memory 170, and are described later in relation to FIGS. 2A to 2C.

The operation signal input unit 180 inputs a user command and sends the command to the DMB controller 160. The digital broadcast receiver 100 of FIG. 1 registers and updates items of the viewing/listening restriction information according to user selections through the operation signal input unit 180.

The digital broadcast receiver 100 must verify that an input command is issued by a user who is authorized to manage the viewing/listening restriction information. To this end, the digital broadcast receiver 100 pre-stores authentication information (for example, a password) for verifying authorization to manage the viewing/listening restriction information. Setting or changing the password may be performed in a manner similar to that of a conventional electric device or using a text message. In particular, a password change using a text message is performed upon reception of a password change message containing related authentication information, an old password and a new password. Only if the authentication information and old password contained in the message are identical to, respectively, authentication information and a password pre-stored in the digital broadcast receiver 100, is the pre-stored password replaced with the new password.

FIGS. 2A to 2C illustrate structures of databases for managing the viewing/listening restriction information in the digital broadcast receiver 100 of FIG. 1. FIG. 2A illustrates records of a time database 170a to manage time intervals to be viewing/listening-restricted, FIG. 2B illustrates records of a program database 170b to manage a list of programs to be viewing/listening-restricted, and FIG. 2C illustrates records of an authentication database 170C to manage authentication information for viewing/listening restriction.

Referring to FIG. 2A, each record of the time database 170a includes a time interval field 171a and viewing/listening field 173a, and is used to store information regarding application of viewing/listening restriction on a time interval basis. FIG. 2A illustrates that DMB viewing/listening is allowed only for a time interval from 12:00:00 to 12:59:59.

Referring to FIG. 1 and FIG. 2A, the DMB controller 160 allows broadcast operation only if the current time from the time counter 150 is within the time interval of 12:00:00 to 12:59:59. That is, the DMB controller 160 activates the DMB data receiver 110, DMB data processor 120 and DMB data output unit 130 only if the current time is within the time interval of 12:00:00 to 12:59:59.

Viewing/listening restriction time intervals are preferably input through the operation signal input unit 180.

Referring to FIG. 2B, each record of the program database 170b includes a PID field 171b, and is used to store and manage the PID of a program to be viewing/listening-restricted according to user requests.

When such information on viewing/listening-restricted programs is stored in the viewing/listening restriction information memory 170, the DMB controller 160 receives the PID of a currently played program from the DMB data processor 120, and blocks reception and/or output of DMB data if the PID is contained in records of the program database 170b.

If the user inputs information on a program to be viewing/listening-restricted through the operation signal input unit 180, the DMB controller 160 stores the information in the viewing/listening restriction information memory 170. In particular, the DMB controller 160 searches the electronic program guide (EPG) using the information on the program to find a corresponding PID of the program, and inserts the found PID into the program database 170b.

Referring to FIG. 2C, the authentication database 170c preferably includes one or more records, each containing authentication information for DMB viewing/listening restriction.

When such authentication information is stored in the viewing/listening restriction information memory 170, the DMB controller 160 analyzes a message received through the wireless communication module 140, extracts authentication information from the message, and compares the extracted authentication information with the corresponding authentication information of the authentication database 170c stored in the viewing/listening restriction information memory 170. The DMB controller 160 performs a requested operation such as a DMB operation mode control or password change only when the extracted and stored authentication information is identical. The DMB controller 160 controls the DMB operation mode and changes a password for the DMB operation control in response to a DMB operation mode control command from a remote site.

The viewing/listening restriction information memory 170 stores and manages one or more of the time database 170a, program database 170b and authentication database 170c. For example, the viewing/listening restriction information memory 170 stores both the time database 170a and program database 170b, and applies a viewing/listening restriction to a particular program during a time interval.

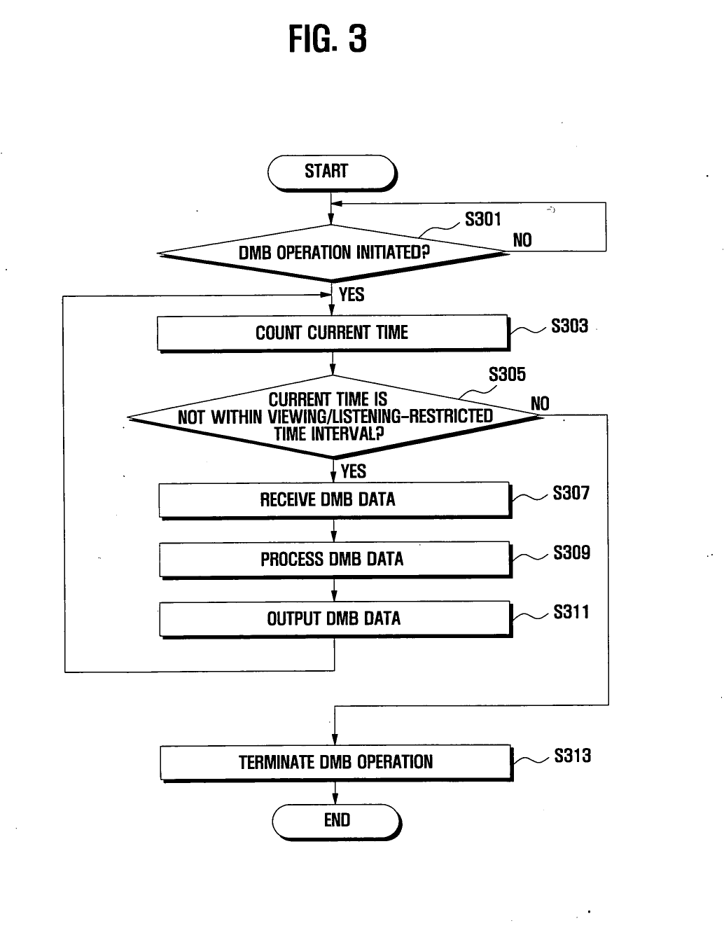

FIG. 3 is a flow chart illustrating a viewing/listening restriction method according to a first embodiment of the present invention. In the method, viewing/listening restriction is applied on the basis of preset time intervals, which are similar to those illustrated in the time database 170a of FIG. 2A stored in the viewing/listening restriction information memory 170 in FIG. 1.

Referring to FIG. 1 and FIG. 3, when DMB operation of the digital broadcast receiver 100 is initiated (S301), the time counter 150 counts the current time to determine whether a current time is a stored viewing/listening restriction time (S303).

The digital broadcast receiver 100 determines whether the current time is within a set viewing/listening-restricted time interval (S305). If the current time is not within any set viewing/listening-restricted time interval, the digital broadcast receiver 100 receives DMB data (S307), processes the received DMB data (S309), and outputs the processed DMB data (S311). That is, the DMB controller 160 controls the DMB data receiver 110, DMB data processor 120, and DMB data output unit 130 to perform steps S307 to S311.

If the current time is within a set viewing/listening-restricted time interval, the digital broadcast receiver 100 terminates the DMB operation (S313) by deactivating the DMB data receiver 110, DMB data processor 120 and DMB data output unit 130.

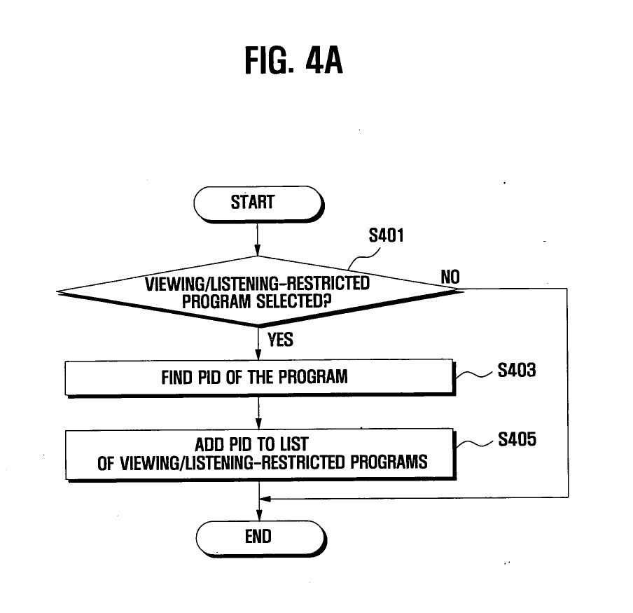

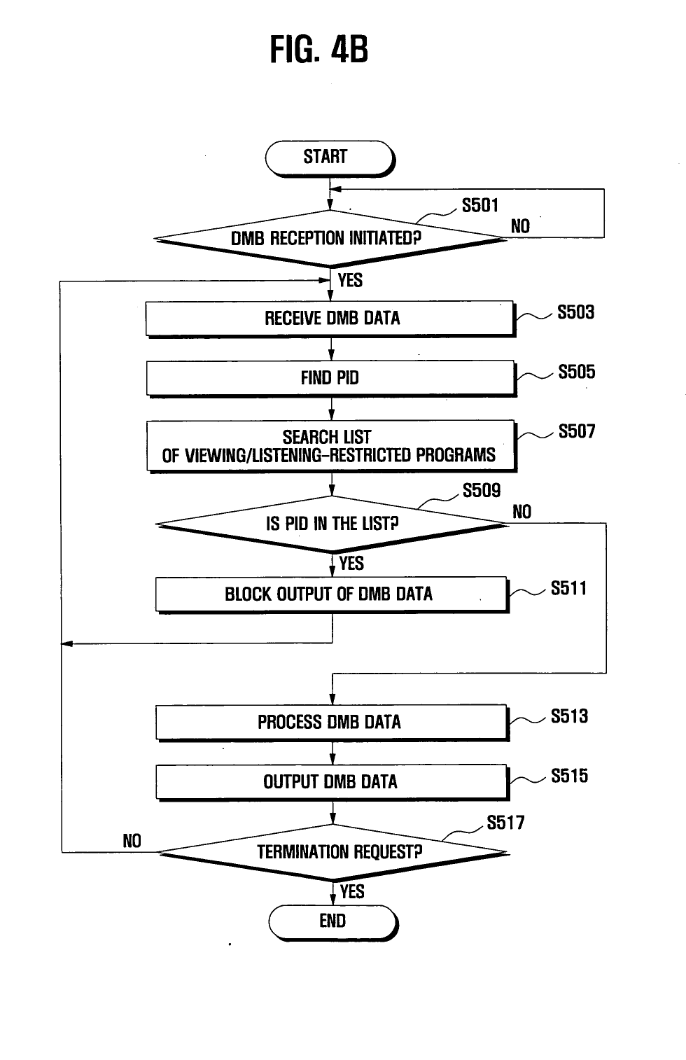

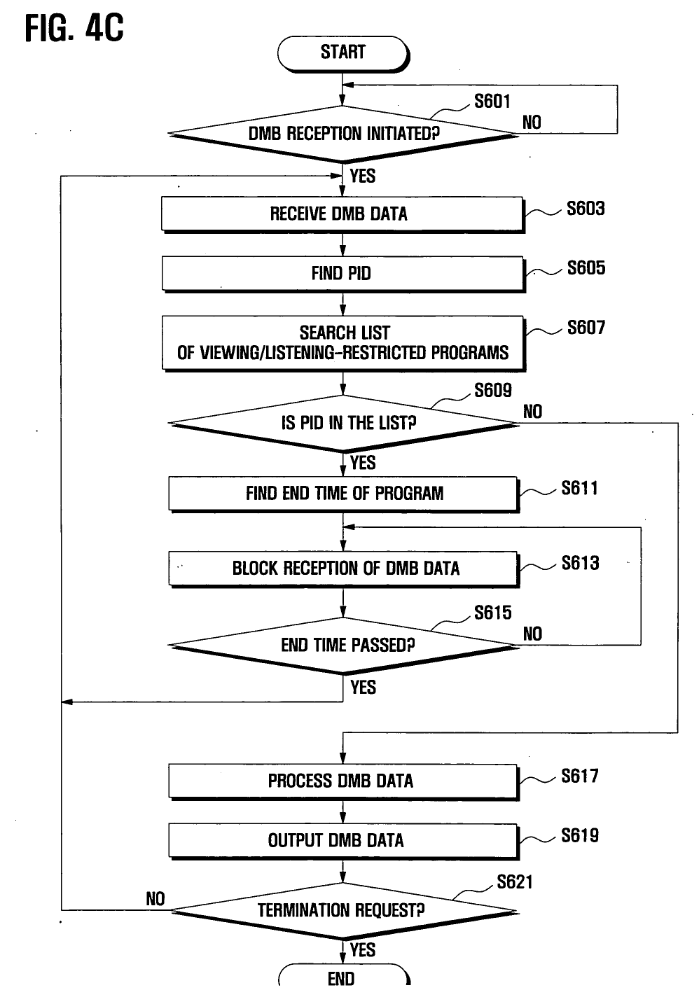

FIGS. 4A to 4C are flow charts illustrating a viewing/listening restriction method according to a second embodiment of the present invention. In particular, FIG. 4A illustrates registering a program to be viewing/listening-restricted, FIG. 4B illustrates blocking output of a viewing/listening-restricted program, and FIG. 4C illustrates blocking reception of a viewing/listening-restricted program.

Referring to FIG. 1 and FIG. 4A, registering a program to be viewing/listening-restricted in the digital broadcast receiver 100 is performed as follows. When an authorized user selects a program to be viewing/listening-restricted (S401), the digital broadcast receiver 100 finds the PID of the selected program (S403), and adds the PID to a list of viewing/listening-restricted programs (S405). That is, when the authorized user selects a program to be viewing/listening-restricted through the operation signal input unit 180, the DMB controller 160 searches the EPG to find the PID of the selected program, and adds the PID to the viewing/listening restriction information memory 170.

Referring to FIG. 1 and FIG. 4B, the viewing/listening restriction method described below blocks output of DMB data on the basis of a list of viewing/listening-restricted programs.

When broadcast operation of the digital broadcast receiver 100 is initiated (S501), the digital broadcast receiver 100 receives DMB data (S503), finds the PID of the DMB data (S505), searches the list of viewing/listening-restricted programs using the PID (S507) and determines whether the PID exists in the list (S509).

If the PID found at step S505 exists in the list of viewing/listening-restricted programs as a result of searching at step S507, the digital broadcast receiver 100 blocks output of the DMB data (S511). Additionally, output of DMB data is blocked until a PID not in the list is found. To this end, the DMB controller 160 controls an operation of the DMB data output unit 130.

If the PID found at step S505 does not exist in the list of viewing/listening-restricted programs, the digital broadcast receiver 100 processes the DMB data received at step S503 (S513) and outputs the processed DMB data (S515).

The above steps S503 to S515 are repeated until a termination request of broadcast operation is input.

Referring to FIG. 1 and FIG. 4C, the viewing/listening restriction method blocks reception of DMB data on the basis of the list of viewing/listening-restricted programs.

When DMB operation of the digital broadcast receiver 100 is initiated (S601), the digital broadcast receiver 100 receives DMB data (S603), finds the PID of the DMB data (S605), searches the list of viewing/listening-restricted programs using the PID (S607) and determines whether the PID exists in the list (S609).

If the PID found at step S605 exists in the list of viewing/listening-restricted programs as a result of searching at step S607, the digital broadcast receiver 100 finds the end time of a program associated with the PID using a pre-stored EPG (S611), and blocks reception of DMB data until the end time of the program (S613). If the end time passes (S615), the digital broadcast receiver 100 unblocks reception of DMB data.

That is, the DMB controller 160 receives the PID of DMB data currently being played from the DMB data processor 120, finds, if the PID is registered in the viewing/listening restriction information memory 170, the end time of a program associated with the PID using the pre-stored EPG, blocks an operation of the DMB data receiver 110, and later unblocks the operation of the DMB data receiver 110 when the end time passes.

If the PID found at step S605 does not exist in the list of viewing/listening-restricted programs, the digital broadcast receiver 100 processes the DMB data received at step S603 (S617), and outputs the processed DMB data (S619).

The above steps S603 to S619 are repeated until a termination request of broadcast operation is input.

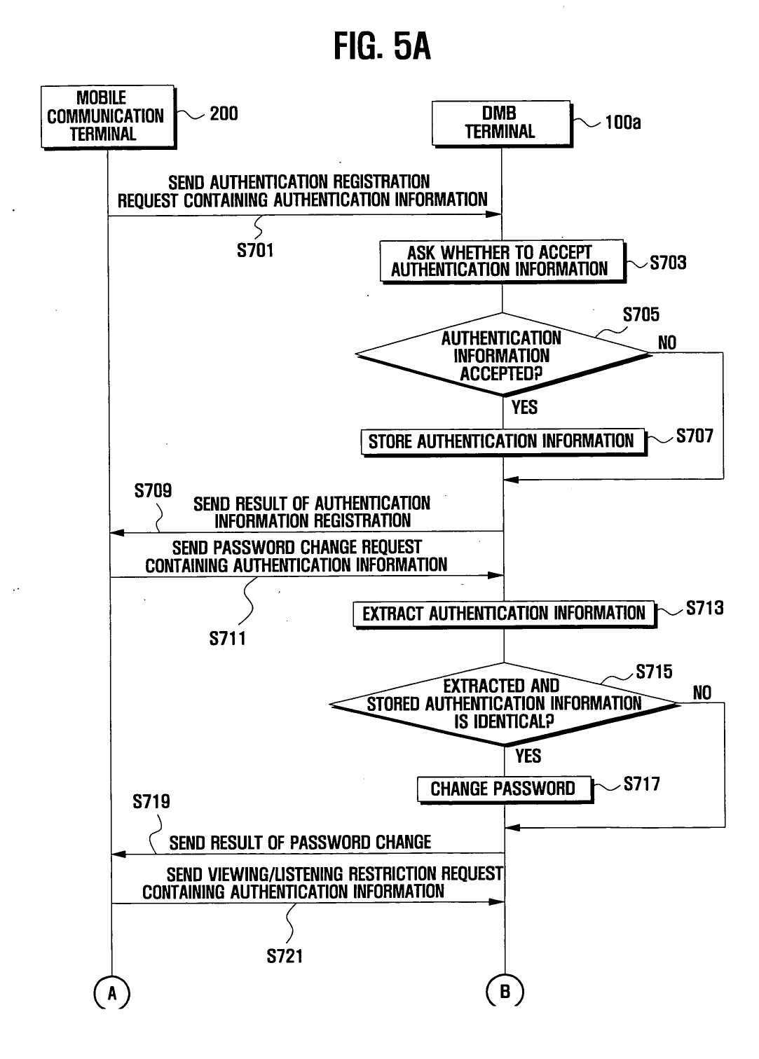

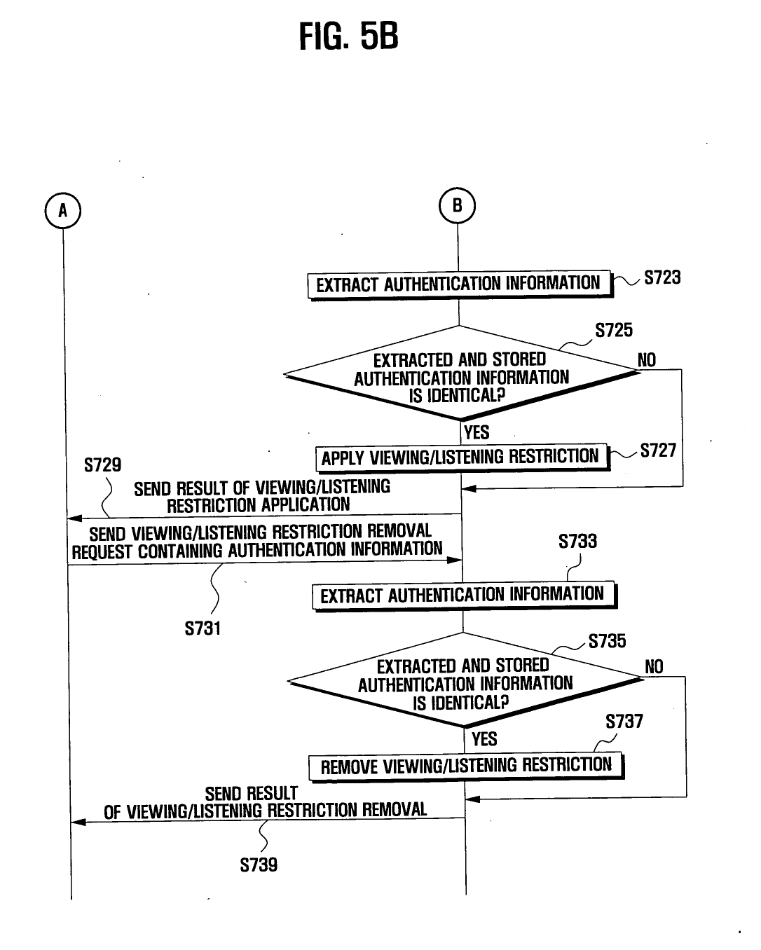

FIGS. 5A to 5B are flow diagrams illustrating a viewing/listening restriction method according to a third embodiment of the present invention. In FIGS. 5A to 5B, DMB operation of a DMB terminal 100a is remotely controlled by a mobile communication terminal 200 via a mobile communication network. The mobile communication terminal 200 may have a DMB receiving capability.

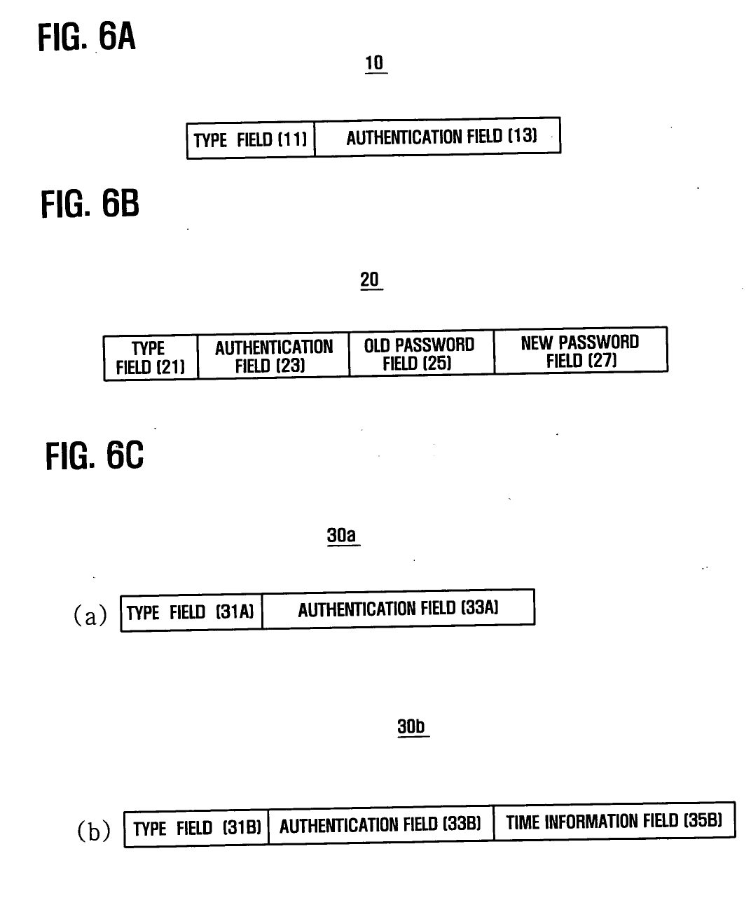

The mobile communication terminal 200 requests the DMB terminal 100a to register authentication information for DMB operation mode control (S701), by sending a request message containing the authentication information to be registered to the DMB terminal 100a. A format of such a request message is illustrated in FIG. 6A, in which the request message includes a type field 11 representing the type of the message, and an authentication field 13 for storing authentication information. The authentication information is one of a phone number or identification number of the mobile communication terminal 200 or a password given by the user of the mobile communication terminal 200.

In return, the DMB terminal 100a informs the user thereof of the request message 10 containing authentication information (S703) to ask the user whether to accept the authentication information. If the user accepts the authentication information (S705), the DMB terminal 100a stores the authentication information transmitted from the mobile communication terminal 200 (S707). The DMB terminal 100a then sends a result of the authentication information registration to the mobile communication terminal 200 (S709).

After this initialization for remote control of the DMB operation, the DMB terminal 100a awaits a control command from the mobile communication terminal 200.

When the user requests a password change for DMB operation of the DMB terminal 100a, the mobile communication terminal 200 creates a password change message, which contains the authentication information registered at steps S701 to S709 in the DMB terminal 100a, and sends the password change message to the DMB terminal 100a (S711). A format of such a password change message is illustrated in FIG. 6B, in which the password change message 20 includes a type field 21 representing the type of the message, an authentication field 23 storing authentication information, an old password field 25 storing a password before change and a new password field 27 storing a password after change. The authentication information is registered at steps S701 to S709 in the DMB terminal 100a.

The DMB terminal 100a extracts authentication information from the received password change message (S713), and determines whether the extracted authentication information is identical to that stored at step S707 (S715) to verify that the user sending the password change message has the right to change the password.

If the extracted authentication information is identical, indicating that the user sending the password change message has the authority to change the password, the DMB terminal 100a performs a password change operation (S717). That is, the DMB terminal 100a determines whether the old password contained in the password change message is identical to a pre-stored password, and replaces, if identical, the pre-stored password with the new password contained in the password change message. The DMB terminal 100a sends a result of the password change operation to the mobile communication terminal 200 (S719).

When the user requests application of viewing/listening restriction to the DMB terminal 100a, the mobile communication terminal 200 creates a viewing/listening restriction message containing the authentication information registered at steps S701 to S709 in the DMB terminal 100a, and sends the viewing/listening restriction message to the DMB terminal 100a (S721). Formats of such a viewing/listening restriction message are illustrated in FIG. 6C. An ordinary viewing/listening restriction message 30a is illustrated in FIG. 6C(a), and a viewing/listening restriction message 30b containing a time interval is illustrated in FIG. 6C(b). Referring to FIG. 6C(a), an ordinary viewing/listening restriction message 30a includes a type field 31A representing the type of the message, and an authentication field 33A storing authentication information. Referring to FIG. 6C(b), a viewing/listening restriction message 30b includes a type field 31B representing the type of the message, an authentication field 33B and a time information field 35B storing time information indicating when to apply viewing/listening restriction to the DMB terminal 100a. At the time information field 35B, information to apply a viewing/listening restriction immediately upon reception of the viewing/listening restriction message, information on time to wait for a predetermined time till a viewing/listening restriction is applied after reception of the viewing/listening restriction message, or information on a specified time to apply a viewing/listening restriction is stored.

The DMB terminal 100a extracts authentication information from the received viewing/listening restriction message (S723), and determines whether the extracted authentication information is identical to that stored at step S707 (S725) to verify that the user sending the viewing/listening restriction message has the authority to apply the viewing/listening restriction.

If the extracted authentication information is identical to the stored authentication information, indicating that the user sending the viewing/listening restriction message has the authority to apply viewing/listening restriction, the DMB terminal 100a performs a requested viewing/listening restriction operation (S727). If time information is contained in the viewing/listening restriction message, the DMB terminal 100a performs a viewing/listening restriction operation on the basis of the time information. For example, if the time information indicates immediate application of viewing/listening restriction, the DMB terminal 100a blocks output or reception of DMB data immediately upon reception of the viewing/listening restriction message. If the time information indicates delayed application of viewing/listening restriction, the DMB terminal 100a blocks output or reception of DMB data at a delayed time after reception of the viewing/listening restriction message. If the time information indicates application of viewing/listening restriction at a specified time, the DMB terminal 100a blocks output or reception of DMB data at the specified time. The DMB terminal 100a then sends a result of the viewing/listening restriction application to the mobile communication terminal 200 (S729).

When the user requests removal of viewing/listening restriction from the DMB terminal 100a, the mobile communication terminal 200 creates a viewing/listening restriction removal message, and sends it to the DMB terminal 100a (S731). In return, the DMB terminal 100a performs a series of steps S733, S735 and S737 for viewing/listening restriction removal. Steps S733, S735 and S737 are similar to steps S723, S725 and S727 for viewing/listening restriction application.

That is, the DMB terminal 100a extracts authentication information from the received viewing/listening restriction removal message (S733), and determines whether the extracted authentication information is identical to that stored at step S707 (S735). If the extracted authentication information is identical, indicating that the user sending the viewing/listening restriction removal message has the authority to remove viewing/listening restriction, the DMB terminal 100a performs a requested viewing/listening restriction removal operation (S737). If removal time information is contained in the viewing/listening restriction removal message, the DMB terminal 100a performs viewing/listening restriction removal on the basis of the removal time information. The type of removal time information is similar to the type of the time information for viewing/listening restriction application. Hence, processing of the removal time information by the DMB terminal 100a is similar to that of the application time information. That is, if the removal time information indicates immediate removal of viewing/listening restriction, the DMB terminal 100a unblocks output or reception of DMB data immediately upon reception of the viewing/listening restriction removal message. If the removal time information indicates delayed removal of viewing/listening restriction, the DMB terminal 100a unblocks output or reception of DMB data at a delayed time after reception of the viewing/listening restriction removal message. If the removal time information indicates removal of viewing/listening restriction at a specified time, the DMB terminal 100a unblocks output or reception of DMB data at the specified time. The DMB terminal 100a then sends a result of the viewing/listening restriction removal to the mobile communication terminal 200 (S739).

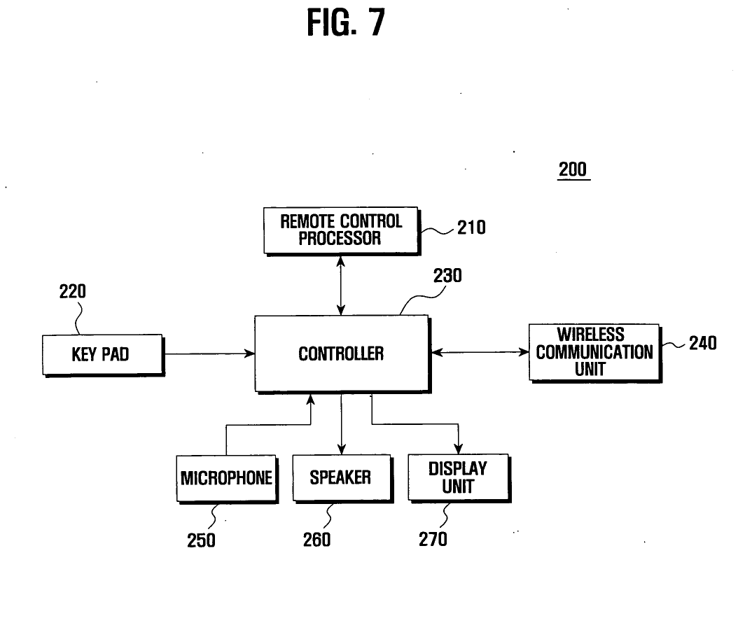

FIG. 7 shows the configuration of the mobile communication terminal 200 according to the present invention. Referring to FIG. 7, the mobile communication terminal 200 includes a remote control processor 210, a keypad 220, a controller 230, a wireless communication unit 240, a microphone 250, a speaker 260 and a display unit 270.

The remote control processor 210 remotely controls a DMB-related operation of an external appliance via a wireless communication network. The remote control processor 210 registers in advance a DMB appliance to be controlled, and controls the registered DMB appliance corresponding to a user selection. For example, the remote control processor 210 creates a message containing a viewing/listening restriction command or viewing/listening restriction removal command, and sends the created message to the DMB appliance through the wireless communication unit 240.

The keypad 220 provides a user interface for inputting a user command to control an operation of the mobile communication terminal 200. In particular, the keypad 220 receives a user input for remote control of the DMB appliance, and transmits the user input to the controller 230. To control DMB operation of the DMB appliance, the keypad 220 receives a user input for changing a password stored in the DMB appliance, and transmits the user input to the controller 230. The keypad 220 also receives a user input for application/removal of viewing/listening restriction to/from the DMB appliance, and transmits the user input to the controller 230. The keypad 220 preferably includes a remote control key for remote control of the DMB appliance.

The controller 230 controls the operation of the mobile communication terminal 200 in response to user inputs from the keypad 220 or through executable programs pre-stored in a memory (not shown). In particular, upon reception of a user input through the keypad 220 to control the DMB appliance, the controller 230 controls the remote control processor 210 according to the user input. For example, to control broadcast operation of the DMB appliance, the controller 230 controls the remote control processor 210 to create a password change message, corresponding to a user input for changing a password stored in the DMB appliance. The controller 230 also controls the remote control processor 210 to create messages requesting application/removal of viewing/listening restriction corresponding to user inputs for application/removal of viewing/listening restriction of the DMB appliance. The messages include authentication information that is verified in advance for remote control between the mobile communication terminal 200 and DMB appliance. The controller 230 pre-stores the authentication information or asks the user for authentication information as needed. The controller 230 provides the authentication information to the remote control processor 210, which then inserts the authentication information into messages to be created (for example, a password change message, viewing/listening restriction message and viewing/listening restriction removal message).

The wireless communication unit 240 provides a communication interface to a wireless communication network. For example, the wireless communication unit 240 transmits through wireless communication a password change message, viewing/listening restriction message and viewing/listening restriction removal message created by the remote control processor 210 to the DMB appliance under the control of the controller 230.

The microphone 250 receives an acoustic signal such as voice from the surrounding environment, and transmits the acoustic signal to the controller 230. The speaker 260 outputs the acoustic signal from the controller 230. The display unit 270 displays image information from the controller 230.

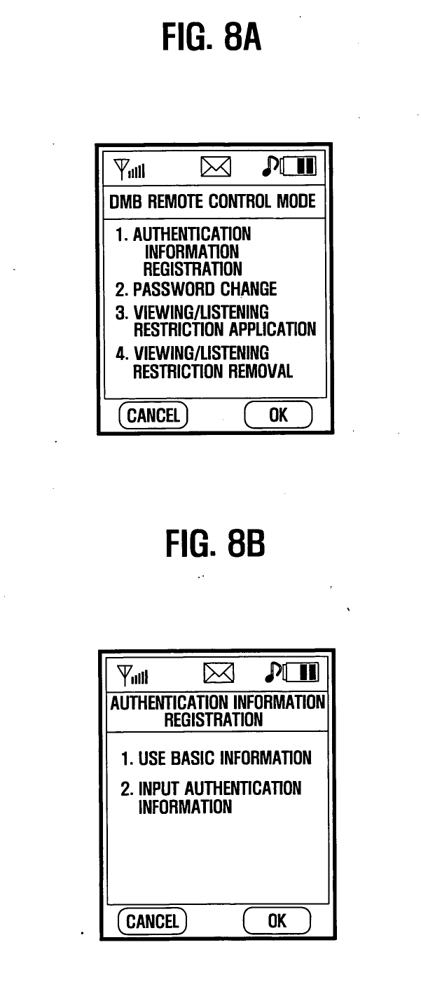

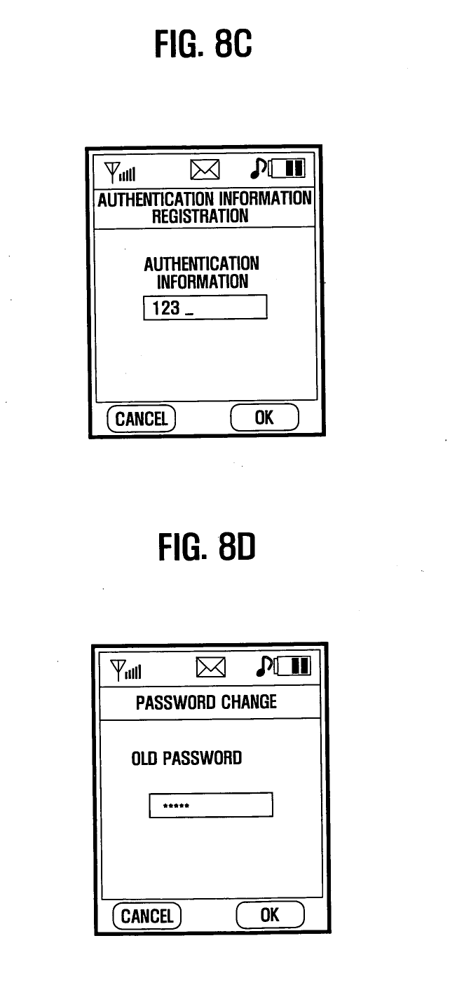

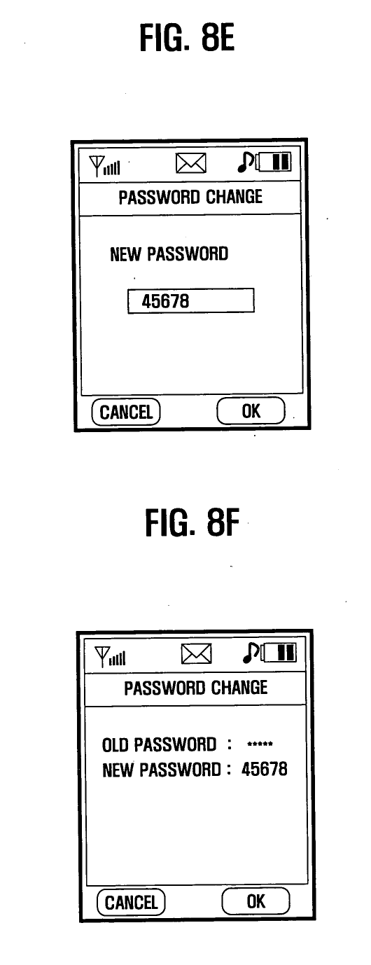

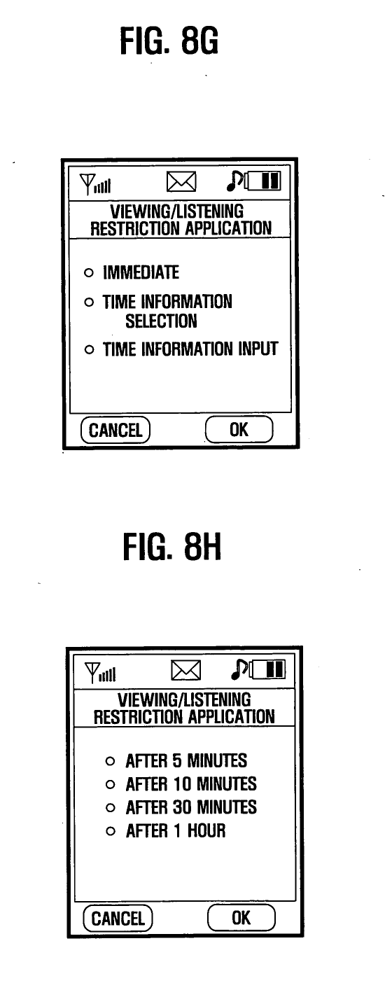

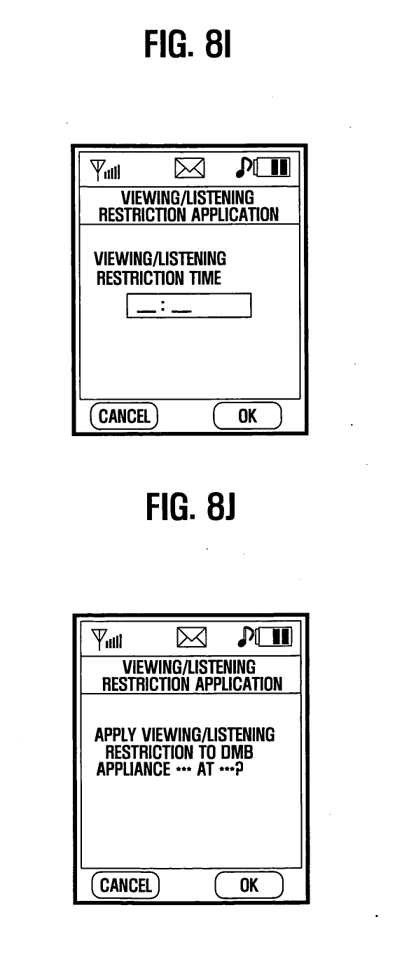

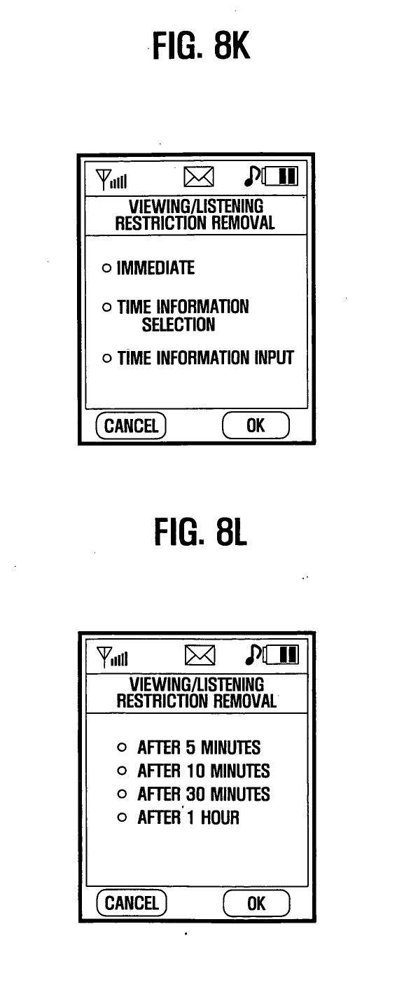

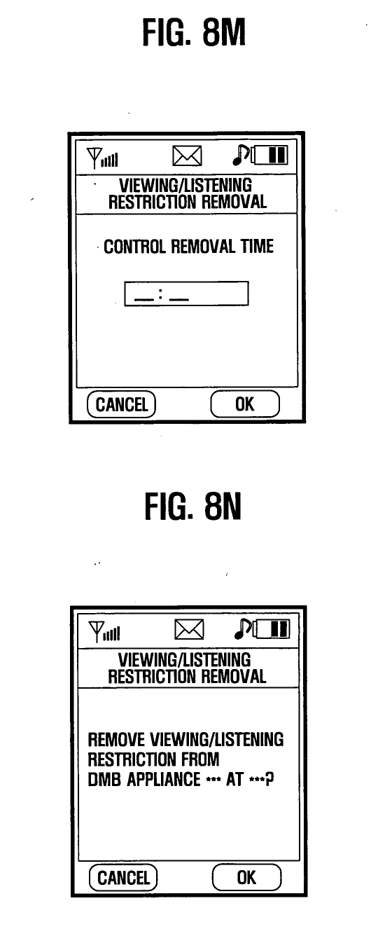

FIGS. 8A to 8N are display screens illustrating remote control of broadcast operation of a DMB appliance using the mobile communication terminal of FIG. 7.

FIG. 8A illustrates a start screen in a DMB remote control mode of the mobile communication terminal to control the DMB appliance. Referring to FIG. 8A, the start screen in the DMB remote control mode includes a list of menu items (‘authentication information registration’, ‘password change’, ‘viewing/listening restriction application’, and ‘viewing/listening restriction removal’) selectable for remote control of the DMB appliance.

FIGS. 8B and 8C illustrate display screens after selection of the menu item ‘authentication information registration’ in FIG. 8A. FIG. 8B illustrates methods to register authentication information, and FIG. 8C illustrates an input window for inputting authentication information after selection of a menu item of ‘input authentication information’ in FIG. 8B.

If the user selects a menu item of ‘use basic information’ in FIG. 8B, the mobile communication terminal sets pre-stored information such as a phone number or identification number thereof as the authentication information.

When the ‘OK’ key is pressed after setting the authentication information, the mobile communication terminal creates a registration message containing the authentication information, and sends the registration message to the DMB appliance to be remotely controlled. The mobile communication terminal also stores the authentication information for future use in the remote control mode.

FIGS. 8D to 8F illustrate display screens of the mobile communication terminal after selection of the menu item ‘password change’ in FIG. 8A to change a password in the remote-controlled DMB appliance. Referring to FIGS. 8D to 8F, for a password change, the mobile communication terminal asks the user to input an ‘old password’ (i.e., ‘password before change’) as shown in FIG. 8D, and a ‘new password’ (i.e., ‘password after change’) as shown in FIG. 8E. If the user inputs the ‘old password’ and ‘new password’, a confirmation screen is displayed as shown in FIG. 8F. When the user presses the ‘OK’ key in FIG. 8F, the mobile communication terminal creates a password change message containing the pre-stored ‘authentication information’, ‘old password’ and ‘new password’, and sends the password change message to a remote-controlled appliance (for example a DMB appliance).

FIGS. 8G to 8J illustrate display screens of the mobile communication terminal after selection of the menu item of ‘viewing/listening restriction application’ in FIG. 8A to apply viewing/listening restriction to the remote-controlled appliance.

FIG. 8G illustrates methods for specifying an application time of viewing/listening restriction after selection of the menu item of ‘viewing/listening restriction application’ in FIG. 8A. FIG. 8H illustrates delay times in application of viewing/listening restriction after selection of a menu item ‘time selection’ in FIG. 8G. FIG. 8I illustrates a window for inputting an application time of viewing/listening restriction after selection of a menu item ‘time input’ in FIG. 8G. FIG. 8J illustrates a step to confirm selection of viewing/listening restriction application and associated application time as shown in FIGS. 8G to 8I. When the user presses the ‘OK’ key in FIG. 8J, the mobile communication terminal creates a viewing/listening restriction message containing the pre-stored ‘authentication information’ and the selected application time, and sends the viewing/listening restriction message to the remote-controlled appliance.

FIGS. 8K to 8N illustrate display screens of the mobile communication terminal after selection of the menu item of ‘viewing/listening restriction removal’ in FIG. 8A to remove viewing/listening restriction from the remote-controlled appliance.

FIG. 8K illustrates methods for specifying a removal time of viewing/listening restriction after selection of the menu item of ‘viewing/listening restriction removal’ in FIG. 8A. FIG. 8L illustrates delay times in removal of viewing/listening restriction after selection of a menu item of ‘time selection’ in FIG. 8K. FIG. 8M illustrates a window for inputting a removal time of viewing/listening restriction after selection of a menu item of ‘time input’ in FIG. 8K. FIG. 8N illustrates a step to confirm selection of viewing/listening restriction removal and associated removal time as shown in FIGS. 8K to 8M. When the user presses the ‘OK’ key in FIG. 8N, the mobile communication terminal creates a viewing/listening restriction removal message containing the pre-stored ‘authentication information’ and the selected removal time, and sends the viewing/listening restriction removal message to the remote-controlled appliance.

As described above, the mobile communication terminal according to the present invention can remotely control broadcast operation of an external DMB appliance via a wireless communication network, thereby enabling application of appropriate viewing/listening restriction to a DMB appliance carried by a young person.

As apparent from the above description, the present invention provides a viewing/listening restriction apparatus and method for digital broadcasting. Viewing/listening restriction can be applied to a digital multimedia broadcasting (DMB) phone by blocking DMB operation of the DMB phone on the basis of preset conditions. DMB operation of the DMB phone is remotely controlled through a mobile communication network so that another person other than the user of the DMB phone can decide whether to block an operation of the DMB phone. Consequently, appropriate viewing/listening restriction can be applied to a DMB phone carried by a young person.

While preferred embodiments of the present invention have been shown and described in this specification, it will be understood by those skilled in the art that various changes or modifications of the embodiments are possible without departing from the spirit and scope of the invention as defined by the appended claims. For example, in the description, although a mobile communication terminal without a digital multimedia broadcasting (DMB) reception capability is used to remotely control a DMB appliance, the mobile communication terminal may have a DMB reception capability. Although the present invention is applied to a DMB receiver, it may also be applied to a receiver for any digital broadcasting, such as digital video broadcasting—handheld (DVB-H), and MediaFLO.

What is claimed is:

1. A viewing and listening restriction method for digital broadcast in a digital broadcast receiver, comprising the steps of:
a) receiving, by the digital broadcast receiver, authentication information through a wireless communication network and registering the received authentication information;
b) setting viewing and listening restriction information for digital broadcast on the basis of selections by a restricting user authorized through the authentication information; and
c) applying viewing and listening restriction to the digital broadcast receiver on the basis of the viewing and listening restriction information.

2. The viewing and listening restriction method of claim 1, wherein step a) further includes:
a-1) receiving, by the digital broadcast receiver, a text message including the authentication information through the wireless communication network;
a-2) requesting a restricted user to accept the authentication information; and
a-3) storing the authentication information according to user acceptance.

3. The viewing and listening restriction method of claim 2, wherein at step a-1) the digital broadcast receiver receives the text message from a mobile communication terminal remotely controlling the digital broadcast receiver.

4. The viewing and listening restriction method of claim 2, wherein at step b) the digital broadcast receiver receives user selection information including the authentication information through the wireless communication network.

5. The viewing and listening restriction method of claim 1, wherein at step b) time information is selected and set as the viewing and listening restriction information.

6. The viewing and listening restriction method of claim 5, wherein the time information is a time interval to wait before application of the viewing and listening restriction.

7. The viewing and listening restriction method of claim 6, wherein at step c) application of viewing and listening restriction is delayed by the time interval after setting the viewing and listening restriction information.

8. The viewing and listening restriction method of claim 5, wherein the time information is a specified start time of viewing and listening restriction.

9. The viewing and listening restriction method of claim 8, wherein at step c) viewing and listening restriction is applied at the specified time.

10. The viewing and listening restriction method of claim 1, wherein at step b) a program to be viewing and listening-restricted is selected and set as the viewing and listening restriction information.

11. The viewing and listening restriction method of claim 10, wherein step b) further includes:
extracting a program identifier (PID) of the selected program from a pre-stored electronic program guide; and
inserting the PID to a list of viewing and listening-restricted programs.

12. The viewing and listening restriction method of claim 11, wherein step c) further includes:
extracting a PID from received digital broadcast data;
determining whether the extracted PID is included in the list of viewing and listening-restricted programs; and
blocking, if the extracted PID is included in the list, output of the digital broadcast data.

13. The viewing and listening restriction method of claim 12, wherein step c) further includes unblocking, if the extracted PID is not included in the list, output of the digital broadcast data.

14. The viewing and listening restriction method of claim 1, wherein step c) further includes:
extracting a PID from received digital broadcast data;
determining whether the extracted PID is included in the list of viewing and listening-restricted programs;
extracting, if the extracted PID is included in the list, an end time of a program associated with the PID from the pre-stored electronic program guide; and
blocking reception of digital broadcast data until the end time of the program.

15. The viewing and listening restriction method of claim 14, wherein step c) further includes unblocking reception of digital broadcast data after the end time of the program.

16. The viewing and listening restriction method of claim 1, further comprising:
d) setting viewing and listening restriction removal information for digital broadcast on the basis of selections by the restricting user authorized through the authentication information; and
e) removing viewing and listening restriction from the digital broadcast receiver on the basis of the viewing and listening restriction removal information.

17. The viewing and listening restriction method of claim 16, wherein at step d) the digital broadcast receiver receives user selection information including the authentication information through the wireless communication network.

18. The viewing and listening restriction method of claim 16, wherein at step d) time information is selected and set as the viewing and listening restriction removal information.

19. The viewing and listening restriction method of claim 18, wherein the time information is a time interval to wait before removal of viewing and listening restriction.

20. The viewing and listening restriction method of claim 19, wherein at step e) removal of viewing and listening restriction is delayed by the time interval after setting the viewing and listening restriction removal information.

21. The viewing and listening restriction method of claim 18, wherein the time information is a specified start time of viewing and listening restriction removal.

22. The viewing and listening restriction method of claim 21, wherein at step e) viewing and listening restriction is removed at the specified time.

23. A digital broadcast receiver, comprising:
a wireless communication module for receiving authentication information for setting viewing and listening restriction information for the digital broadcast receiver via a wireless communication network;
a digital broadcast receiving unit for receiving digital broadcast data;
a digital broadcast data processor for processing the received digital broadcast data;
a digital broadcast data output unit for outputting the processed digital broadcast data;
a keypad for inputting an operation command from a user;
a controller for setting viewing and listening restriction information for digital broadcast according to selections by a user authorized through the authentication information, and for applying viewing and listening restriction to the digital broadcast receiver on the basis of the viewing and listening restriction information; and
a memory unit for storing the authentication information and viewing and listening restriction information.

24. The digital broadcast receiver of claim 23, wherein the keypad receives time information from the authorized user and transmits the time information as the viewing and listening restriction information to the controller.

25. The digital broadcast receiver of claim 24, wherein the time information is used for application of viewing and listening restriction to digital broadcast.

26. The digital broadcast receiver of claim 25, wherein the time information is a time interval to wait before application of viewing and listening restriction.

27. The digital broadcast receiver of claim 26, wherein the controller sets the viewing and listening restriction information using the time information, waits for the duration of the time interval, and then applies viewing and listening restriction to digital broadcast.

28. The digital broadcast receiver of claim 25, wherein the time information is a specified start time of viewing and listening restriction.

29. The digital broadcast receiver of claim 28, wherein the controller applies viewing and listening restriction at the specified time.

30. The digital broadcast receiver of claim 23, wherein the viewing and listening restriction information is information on a viewing and listening-restricted program.

31. The digital broadcast receiver of claim 30, wherein to set the viewing and listening restriction information, the controller extracts a program identifier (PID) of the viewing and listening-restricted program from a pre-stored electronic program guide, and stores the extracted PID in the memory unit.

32. The digital broadcast receiver of claim 31, wherein to apply viewing/listening restriction, the controller determines whether a PID extracted from received digital broadcast data is stored in the memory unit, and blocks output of the digital broadcast data, if the PID is stored in the memory unit.

33. The digital broadcast receiver of claim 32, wherein the controller unblocks output of the digital broadcast data, if the PID is not stored in the memory unit.

34. The digital broadcast receiver of claim 31, wherein to apply viewing and listening restriction, the controller determines whether a PID extracted from received digital broadcast data is stored in the memory unit, and blocks reception of digital broadcast data, if the PID is stored in the memory unit.

35. The digital broadcast receiver of claim 34, wherein the controller blocks reception of digital broadcast data until an end time of a program associated with the PID, if the PID is stored in the memory unit.

36. The digital broadcast receiver of claim 35, wherein the controller extracts the end time of the program from the pre-stored electronic program guide.

37. The digital broadcast receiver of claim 32, wherein the digital broadcast data processor extracts a PID from digital broadcast data received by the digital broadcast receiving unit, and transmits the extracted PID to the controller.

38. The digital broadcast receiver of claim 23, wherein the wireless communication module receives a text message including the authentication information through the wireless communication network.

39. The digital broadcast receiver of claim 38, wherein the wireless communication module receives the text message from a mobile communication terminal remotely controlling the digital broadcast receiver.

40. The digital broadcast receiver of claim 23, wherein the keypad receives time information from the authorized user and transmits the time information as viewing and listening restriction removal information to the controller.

41. The digital broadcast receiver of claim 40, wherein the time information is used to remove viewing and listening restriction for digital broadcast.

42. The digital broadcast receiver of claim 41, wherein the time information is a time interval to wait before removal of viewing and listening restriction.

43. The digital broadcast receiver of claim 42, wherein the controller sets the viewing and listening restriction removal information using the time information, waits for the duration of the time interval, and then removes viewing and listening restriction for digital broadcast.

44. The digital broadcast receiver of claim 41, wherein the time information is a specified start time of viewing and listening restriction removal.

45. The digital broadcast receiver of claim 44, wherein the controller removes viewing and listening restriction at the specified time.

46. The digital broadcast receiver of claim 23, wherein the wireless communication module receives a text message including the authentication information and time information for application or removal of viewing and listening restriction.

47. A mobile communication terminal, comprising:
a remote control processor for creating a control message to control digital broadcast operation of an external appliance through a mobile communication network;
an input unit for inputting an operation command from a user to remotely control the external appliance;
a controller for controlling the remote control processor in response to the operation command; and
a wireless communication unit for transmitting the control message created by the remote control processor to the external appliance.

48. The mobile communication terminal of claim 47, wherein the remote control processor creates at least one of a password change message to change a password that is stored in the external appliance for verification of a right to control digital broadcast reception, a viewing and listening restriction message to apply viewing and listening restriction to the external appliance, and a viewing and listening restriction removal message to remove viewing and listening restriction from the external appliance.

49. The mobile communication terminal of claim 47, wherein the input unit includes a remote control key for remotely controlling digital broadcast operation of the external appliance.
